(19) United States
(12) Patent Application Publication
(10) Pub. No.: US 2014/0006370 A1
(43) Pub. Date: Jan. 2, 2014

(54) SEARCH APPLICATION FOR SEARCH ENGINE RESULTS PAGE

(71) Applicants: Jitu Kumar Keshri, Hyderabad (IN); Zhaowei Charlie Jiang, Palo Alto, CA (US); Steven William Macbeth, Redmond, WA (US)

(72) Inventors: Jitu Kumar Keshri, Hyderabad (IN); Zhaowei Charlie Jiang, Palo Alto, CA (US); Steven William Macbeth, Redmond, WA (US)

(73) Assignee: Microsoft Corporation, Redmond, WA (US)

(21) Appl. No.: 13/539,346

(22) Filed: Jun. 30, 2012

(51) Int. Cl. G06F 17/30

(52) U.S. Cl. 707/706; 707/E17.108

(57) ABSTRACT

Among other things, one or more techniques and/or systems are provided for generating and/or displaying a search application within a search engine results page. In one example, a declaration for a search application may be used to generate the search application. The declaration may comprise one or more data bindings of variable values to variables defined within a template. The declaration may comprise one or more conditions that may trigger display of the search application within a search engine results page. In this way, the search application may be displayed within a search engine results page of a search based upon a search characteristic of the search corresponding to a condition of the search application. The search application may provide a user with an interactive experience within the search engine results page (e.g., a pizza application may allow a user to order pizza without leaving the search engine results page).

### BACKGROUND

Many internet users may discover and interact with content through a search engine. For example, a user may search for websites, images, videos, and/or other content by submitting a search query to a search engine. The search engine may provide the user with a search engine results page comprising content relevant to the search query (e.g., a link to a website, an image from a social network website, a video from a video sharing website, etc.). The search engine results page may be based upon content crawled and/or indexed from various internet sources. However, an internet source (e.g., provider of content) may have little control over how content associated with the internet source is displayed within the search engine results page and/or may lack a manner of specifying what actions can be taken on such content. As such, content displayed within the search engine results page may provide little interactivity for a user beyond merely viewing an image or accessing a website from a link.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

Among other things, one or more systems and/or techniques for generating and/or displaying a search application within a search engine results page are provided herein. It may be appreciated that in one example, a search application may comprise an interactive user interface that may be displayed within a search engine results page. The search application may comprise one or more views. A view may represent a user experience (UX) presentation of the search application (e.g., a first view may represent a restaurant menu UX screen, a second view may represent a food order submission UX screen, and/or other views that may represent various UX screens of a restaurant search application). In one example, a third party may design and/or customize a search application using declarative XML to specify what data is to be shown, how the data is to look, and/or what operations the user can perform on the data, for example. For example, a restaurant third party may fill out and/or customize a template for a restaurant search application. In this way, interactive search applications, which may be designed by third parties other than a search engine provider, may be displayed within a search engine results page (e.g., based upon a search characteristic of a search corresponding to a condition that triggers display of a search application).

In one example of generating a search application, a declaration for a search application may be received (e.g., a restaurant representative may fill out and/or customize a restaurant search application template using declarative XML). The declaration may comprise a data binding of a variable value (e.g., a string, an API call to remote data, contextual data, a data feed, etc.) to a variable defined within a template for the search application. For example, a string “Dan's Pizza Shop” can be bound to a Title variable; an API call to a price database server for a pizza price can be bound to a pizza price variable; etc. In one example of data binding using an API call, a response of the API call may be mapped to one or more variables within one or more views of the search application. The declaration may comprise a condition that triggers display of the search application within a search engine results page. For example, the condition may trigger the display based upon a search query (e.g., “restaurant”), a search result (e.g., “www.WorldsBestPizzaByTheDish.com”), a classified entity (e.g., a food entity determined by a search query classifier), etc. The declaration may define one or more views for the search application (e.g., a restaurant menu view, an order out view, etc.). In this way, the search application can be generated based upon the declaration.

In one example of displaying a search application, a user may perform a search through a search engine by submitting a search query to the search engine. One or more search characteristics associated with the search can be determined (e.g., a search query term, a URL of a search result, a location of the user, an entity classified from the search query, etc.). Responsive to a search characteristic corresponding to a condition that triggers display of a search application (e.g., where the search application is defined by a third party other than a provider of the search engine); the search application may be displayed (e.g., by a provider of the search engine) within a search engine results page for the search. For example, a pizza restaurant search application (e.g., and/or a view of the pizza restaurant search application) may be displayed within a search engine results page of a search based upon a search query (e.g., comprising a query term “restaurant”) of the search corresponding to a condition (e.g., a search query condition of “restaurant”) that triggers display of the pizza restaurant search application. In this way, the user may interact with the pizza restaurant search application to view various data (e.g., view a menu, view available tables for reservation, etc.) and/or perform various operations (e.g., submit a pizza order, reserve a table, submit a restaurant review, etc.) without navigating away from the search engine results page, for example.

To the accomplishment of the foregoing and related ends, the following description and annexed drawings set forth certain illustrative aspects and implementations. These are indicative of but a few of the various ways in which one or more aspects may be employed. Other aspects, advantages, and novel features of the disclosure will become apparent from the following detailed description when considered in conjunction with the annexed drawings.

### DESCRIPTION OF THE DRAWINGS

FIG. 1 is a flow diagram illustrating an exemplary method of generating a search application for display within a search engine results page.

FIG. 2 is a flow diagram illustrating an exemplary method of displaying a search application within a search engine results page.

FIG. 3 is a component block diagram illustrating an exemplary system for generating a search application for display within a search engine results page.

FIG. 4 is a component block diagram illustrating an exemplary system for displaying a search application within a search engine results page.

FIG. 5 is an illustration of an example of displaying a view of a search application based upon user interaction with the search application.

FIG. 6 is an illustration of an example of displaying a view of a search application based upon user interaction with the search application.

FIG. 7 is an illustration of an example of displaying a first search application and a second search application within a search engine results page.

FIG. 8 is an illustration of an exemplary computer-readable medium wherein processor-executable instructions configured to embody one or more of the provisions set forth herein may be comprised.

FIG. 9 illustrates an exemplary computing environment wherein one or more of the provisions set forth herein may be implemented.

### DETAILED DESCRIPTION

The claimed subject matter is now described with reference to the drawings, wherein like reference numerals are generally used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, structures and devices are illustrated in block diagram form in order to facilitate describing the claimed subject matter.

Conventional search engines provide search engine results pages that comprise links to websites, images, videos, and/or other content. A search engine results page may present content to a user with minimal interactivity (e.g., the user may view an image or invoke a hyperlink to navigate to a website). Because a search engine may build the search engine results page based upon crawled and/or indexed content, a third party, such as a website provider, may have little to no control over how content is displayed to a user through the search engine results page and/or may lack a manner of specifying what actions can be taken on such content. Accordingly, it may be advantageous to allow third parties to declare a search application which generally corresponds to an interactive user interface of third party content that may be displayed within a search engine results page.

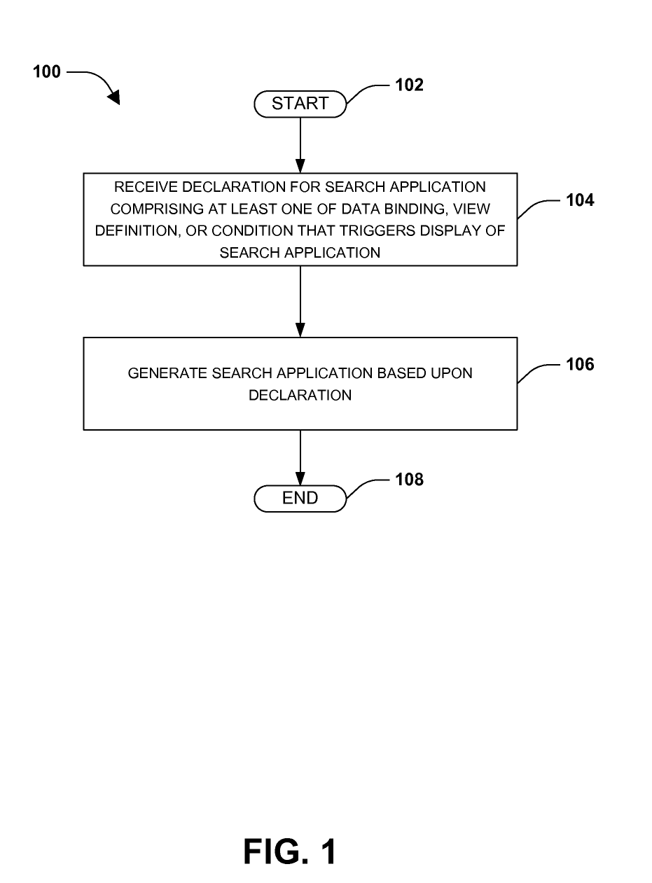

One embodiment of generating a search application for display within a search engine results page is illustrated by an exemplary method 100 in FIG. 1. At 102, the method starts. At 104, a declaration for a search application may be received. For example, a website provider (e.g., an auction house website that is a third party to a search engine provider) can access a search application generator user interface to fill out and/or customize a search application template using declarative XML (e.g., and/or other language). The declaration may comprise a data binding of a variable value to a variable defined within a template for the search application. It may be appreciated that the declaration may comprise one or more data bindings. For example, the declaration may comprise a first data binding of a string “Auction House” to a Title variable, a second data binding of contextual data (e.g., a zip code of the user) to a text variable of an input textbox (e.g., a find auction house textbox that may locate auction houses based upon a zip code), a third data binding of a remote API call (e.g., to an image server) to an image variable, a fourth data binding of a data feed to a news label variable, etc.

The declaration may comprise a condition that triggers display of the search application within a search engine results page. The condition may comprise a grammar based rule (e.g., does a query term of a search query match a string “sell my stuff”), a classifier based rule (e.g., does an entity, classified from the search query by a query classifier, match a retail entity), a URL based rule (e.g., does a URL of a search result match a “www.purchase.com” URL), and/or other rules. In this way, the condition may specify that the search application is to be displayed within a search results page based upon, among other things, a search query submitted to the search engine, a search result for the search query, and/or a classified entity associated with the search query, for example. It may be appreciated that in one example, the declaration may comprise one or more conditions that trigger the display of the search application. In one example, the declaration may comprise a condition include list comprising one or more conditions that trigger the display of the search application (e.g., a whitelist). The declaration may comprise a condition exclude list comprising one or more conditions that do not trigger the display of the search application (e.g., a blacklist). In another example of a condition (e.g., and/or a view condition for a view of the search application), the condition may specify that the search application (e.g., and/or a view of the search application) is to be displayed based upon user interaction. For example, responsive to a user invoking a sell button of the auction house search application, a sell view may be displayed based upon a view condition of the sell view corresponding to the invocation of the sell button. In another example, a default view may be specified for the search application, such that the default view may be displayed based upon a condition that triggers the display of the search application. In another example, a fallback view may be specified for the search application, such that the fallback view may be displayed based upon a condition that triggers the display of the search application, but that does not trigger the display of the default view (e.g., such as where a classified entity required for the default view is not present in a search context).

In one example, the declaration may comprise an operation defined within the template. The operation may correspond to functionality of the search application that may be invoked through the search application (e.g., a user may invoke a purchase operation through the auction house search application to buy an item). In this way, the search application may provide an interactive user experience through the search engine results page. It may be appreciated that in one example, the declaration may comprise one or more operations.

In one example, the declaration may comprise one or more view definitions. That is, the declaration may define one or more views, such as a first view, for the search application. A view may represent a user experience (UX) presentation of the search application. For example, a first view may comprise a sell view that displays information and/or exposes operations relating to selling items through the auction house search application. A second view may comprise a buy view that displays information and/or exposes operations relating to buying items through the auction house search application. In one example, the declaration may comprise a view condition for the first view. For example, the view condition may specify that a particular view is to be displayed based upon a search characteristic of a search (e.g., a first/sell view may be displayed based upon a search query, a search result, a classified entity of the search query, etc.) and/or based upon user interaction with the search application (e.g., a second/buy view may be displayed based upon a user invoking a buy button of the auction house search application). The declaration may comprise a view template for the first view. The view template may define what data is to be displayed, how the data is to be visually presented, and/or what operations can be invoked through the first view. The declaration may comprise a view data binding for the first view. For example, the view data binding may bind character strings, contextual data, and/or remote data as variable values to variables of the first view (e.g., a string “Sell Your Stuff” may be bound to a Title variable).

At 106, the search application may be generated based upon the declaration. In one example, the one or more views of the search application may be generated. In this way, the search application may be available for display within a search engine results page responsive to a condition for the search application and/or a view condition for a view triggering. It may be appreciated that one or more instances of the search application (e.g., having respective views of the search application) and/or other search applications may be displayed within a same (or different) search engine results page. In one example, a user may perform a search by submitting a search query to a search engine. Responsive to a search characteristic of the search corresponding to a condition of the search application (e.g., a URL of a search result matching a URL based rule), the search application may be displayed within a search engine results page of the search (e.g., data binding may be performed to bind data associated with variable values to variables). Because the search application may provide the user with an interactive experience, one or more operations (e.g., the user may list an item for sale through the sale view of the auction house search application) may be performed by the search application based upon user interaction. In another example, a view of the search application may be displayed within the search engine results page based upon a search characteristic and/or user interaction corresponding to a view condition of the view. In this way, the search application and/or one or more views of the search application may be display within the search engine results page to provide the user with an interactive experience. At 108, the method ends.

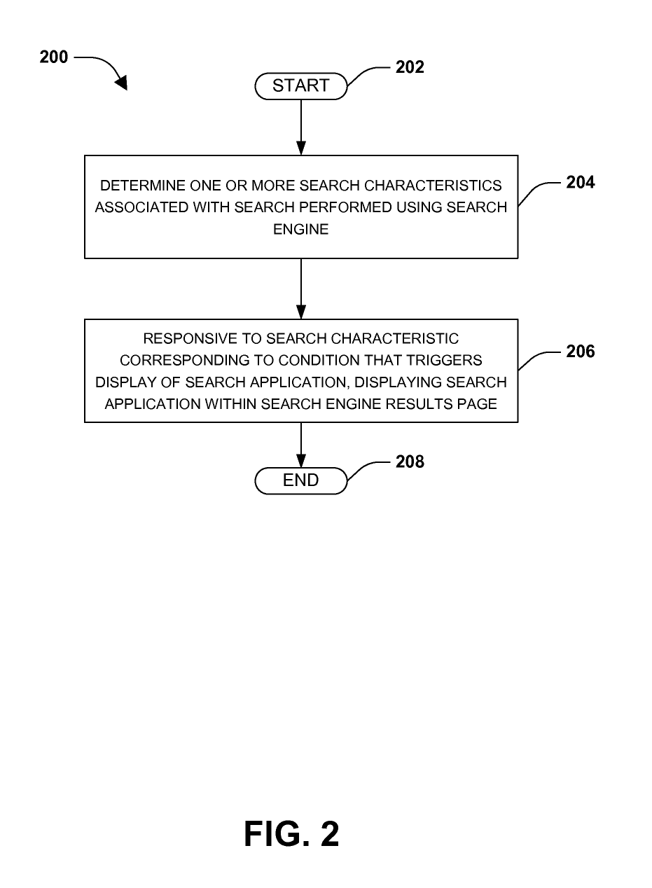

One embodiment of displaying a search application within a search engine results page is illustrated by an exemplary method 200 of FIG. 2. At 202, the method starts. At 204, one or more search characteristics associated with a search performed using a search engine may be determined. For example, a user may submit a search query “find local pizza restaurant” to the search engine. The search engine may generate one or more search results, such as a URL “www.BestPizzaPieInTown.com” of a pizza shop website. A first search characteristic may be determined as a pizza entity based upon a classifier classifying the search query. A second search characteristic may be determined as the URL “www.BestPizzaPieInTown.com”. Similarly, additional search characteristics may be obtained based upon the search. In this way, the one or more search characteristics associated with the search may be determined.

At 206, responsive to a search characteristic corresponding to a condition that triggers display of the search application (e.g., a pizza restaurant search application); the search application may be displayed within a search engine results page for the search. It may be appreciated that in one example, the search application may be defined by an entity other than a provider of the search engine (e.g., a third party, such as pizza shop provider of the pizza shop website). During display of the search application, one or more variable values (e.g., defined as static strings, context based data, API calls to remote data, data feeds, etc.) may be bound to one or more variables of the search application. In one example, an API call to a price database server may be performed to retrieve pizza pricing for binding to a pizza price variable within the pizza restaurant search application. In another example, contextual data, such as a current zip code of the user, may be bound to a nearest pizza shop variable within the pizza restaurant search application.

Because the search application may provide an interactive user experience, the search application may be invoked to perform various operations based upon user interaction with the search application. For example, a user may click a submit pizza order button, which may invoke the search application to perform a pizza order operation. In this way, the user may order pizza through the search application on the search engine results page (e.g., without navigating away from the search engine results page).

The search application may comprise one or more views. For example, a first view may comprise a franchise information page for the pizza restaurant search application; a second view may comprise a menu page for the pizza restaurant search application, etc. A view may be displayed based upon a search characteristic and/or user interaction with the search application. In one example, responsive to a user submitting a search query “pizza menu” to a search engine, the second view comprising the menu page may be displayed in a search engine results page for the search query. In another example, the user may click a franchise button on the pizza restaurant search application to navigate to the first view comprising the franchise information page. In this way, various views for the search application may be displayed to provide the user with an interactive experience (e.g., without navigating away from the search engine results page). At 208, the method ends.

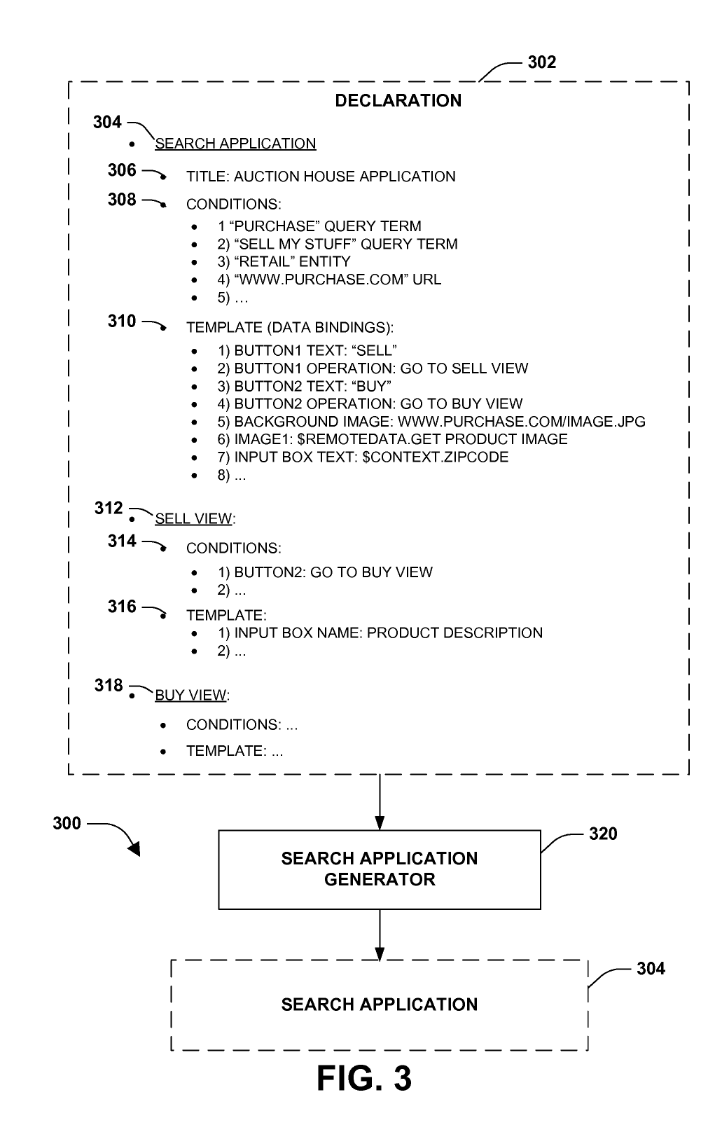

FIG. 3 illustrates an example of a system 300 configured for generating a search application 304 for display within a search engine results page. The system 300 may comprise a search application generator 320. The search application generator 320 may be configured to receive a declaration 302 for the search application 304. For example, the declaration 302 may define various aspects of the search application 304 through declarative XML (e.g., and/or other language) (e.g., what data to display, how to visually format the data, what operations may be invoked, etc.). The declaration 302 may comprise a data binding of a variable value to a variable defined within a template for the search application (e.g., template 310). The declaration 302 may comprise a condition that triggers display of the search application 304 within a search engine results page (e.g., conditions 308). In one example, the declaration 302 may define one or more views for the search application 304 (e.g., a sell view 312, a buy view 318, and/or other views not illustrated).

The declaration 302 may comprise the template 310 defining various aspects of the search application 304, such as what objects to display, how such objects are to visually appear, what operations may be invoked through the search application 304, etc. For example, the template 310 may define one or more data bindings for the search application 304. In one example, a string “sell” may be bound to a button1 text variable of a first button. A change view operation to navigate to the sell view 312 of the search application 304 may be bound to an operation variable of the first button. A string “buy” may be bound to a button2 text variable of a second button. A change view operation to navigate to the buy view 318 of the search application 304 may be bound to an operation variable of a second button. An image remotely located at a “www.purchase.com/image.jpg” URL may be bound to a background image variable. An API call to retrieve a product image from a remote source may be bound to an image1 variable. Contextual data, such as a zip code of a user, may be bound to a text variable of an input box. In this way, various types of variable values (e.g., character strings, contextual data, remote data, feed data, etc.) can be bound to variables of the search application 304.

In one example of the declaration 302, the declaration 302 may specify a string “Auction House Application” (e.g., a variable value) for a Title variable 306 of the search application 304. The declaration 302 may comprise conditions 308 that trigger display of the search application 304. In one example, a first condition may specify that the search application 304 is to be displayed based upon a user submitting a search query to a search engine comprising a query term “purchase”. A second condition may specify that the search application 304 is to be displayed based upon a user submitting a search query to a search engine comprising a query term “sell my stuff”. A third condition may specify that the search application 304 is to be displayed based upon a search that is associated with a retail entity (e.g., a query classifier may classify the search query as relating to the retail entity). A fourth condition may specify that the search application 304 is to be displayed based upon a URL of a search result matching a “www.purchase.com” URL. It may be appreciated that these are examples and that additional and/or other conditions are contemplated. In this way, the declaration 302 may define various conditions (e.g., rules) that trigger display of the search application 304.

The declaration 302 may define the sell view 312 for the search application 304. For example, the declaration 302 may define conditions 314 for the sell view. For example, the declaration 302 may define a view condition action associated with a button2 of the sell view that transitions the display of the sell view to the buy view responsive to a user clicking the button2 within the sell view. The declaration 302 may define a template 316 (e.g., a string “product description” may be bound to a text variable of an input box) for the sell view 312. The declaration 302 may define the buy view 318 for the search application 304. For example, the declaration 302 may define conditions and/or a template for the buy view 318. In this way, the search application generator 320 may be configured to generate the search application 304 (e.g., and/or one or more views for the search application 304) based upon the declaration 302.

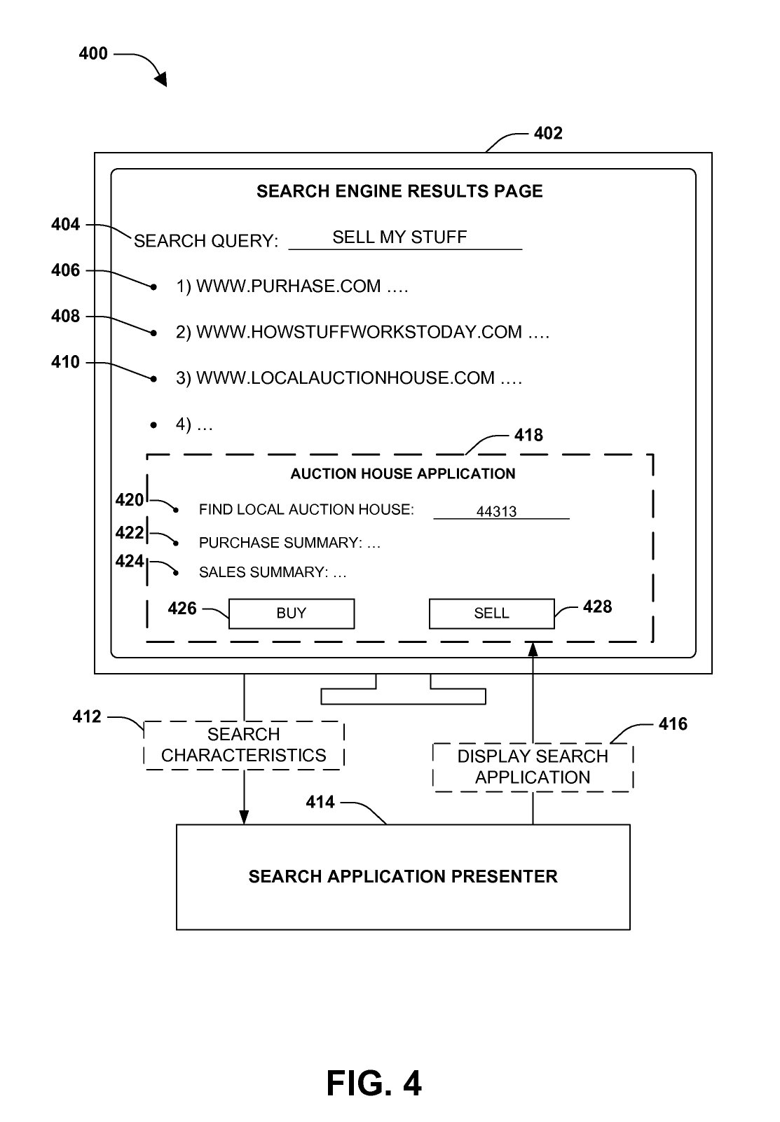

FIG. 4 illustrates an example of a system 400 configured for displaying a search application within a search engine results page. The system 400 may comprise a search application presenter 414. The search application presenter 414 may be configured to display a search application within a search engine results page based upon one or more search characteristics of a search. For example, the search application presenter 414 may determine whether a search characteristic (e.g., a query term of a search query, a URL of a search result, an entity classified for the search query, and/or other search characteristics) corresponds to one or more conditions that trigger display of the search application.

In one example, a user may perform a search through a search engine by submitting a search query 404 comprising the query terms “sell my stuff”. The search engine may generate a set of search results comprising a first search result 406 (e.g., “www.purchase.com”), a second search result 408 (e.g., “www.howstuffworkstoday.com”), a third search result 410 (e.g., “www.localauctionhouse.com”), and/or other search results. The search application presenter 414 may determine one or more search characteristics 412 associated with the search (e.g., the search query 404, the first search result 406, the second search result 408, the third search result 410, a “retail” entity, etc.).

The search application presenter 414 may determine that a search characteristic corresponds to a condition of an auction house application 418. In one example, the search query 404 may correspond to a first condition that triggers display of the auction house application 418 when a search query corresponds to “sell my stuff”. In another example, the first query result 406 may correspond to a second condition that triggers display of the auction house application 418 when a search result comprises a “www.purchase.com” URL. In this way, the search application presenter 414 may display 416 the auction house application 418 within a search engine results page 402 for the search. In one example, data binding may be performed for the auction house application 418 (e.g., contextual data, such as a zip code 44313, may be bound to a find local auction house object 420, purchase data may be bound to a purchase summary object 422, sales data may be bound to a sales summary object 424, “buy” text may be bound to a buy button 426, “sell” text may be bound to a sell button 428, etc.). The auction house application 418 may provide the user with an interactive user experience. For example, the user may view purchase data, view sales data, locate auction houses, buy items, and/or sell items through the auction house application 418 (e.g., without leaving the search engine results page).

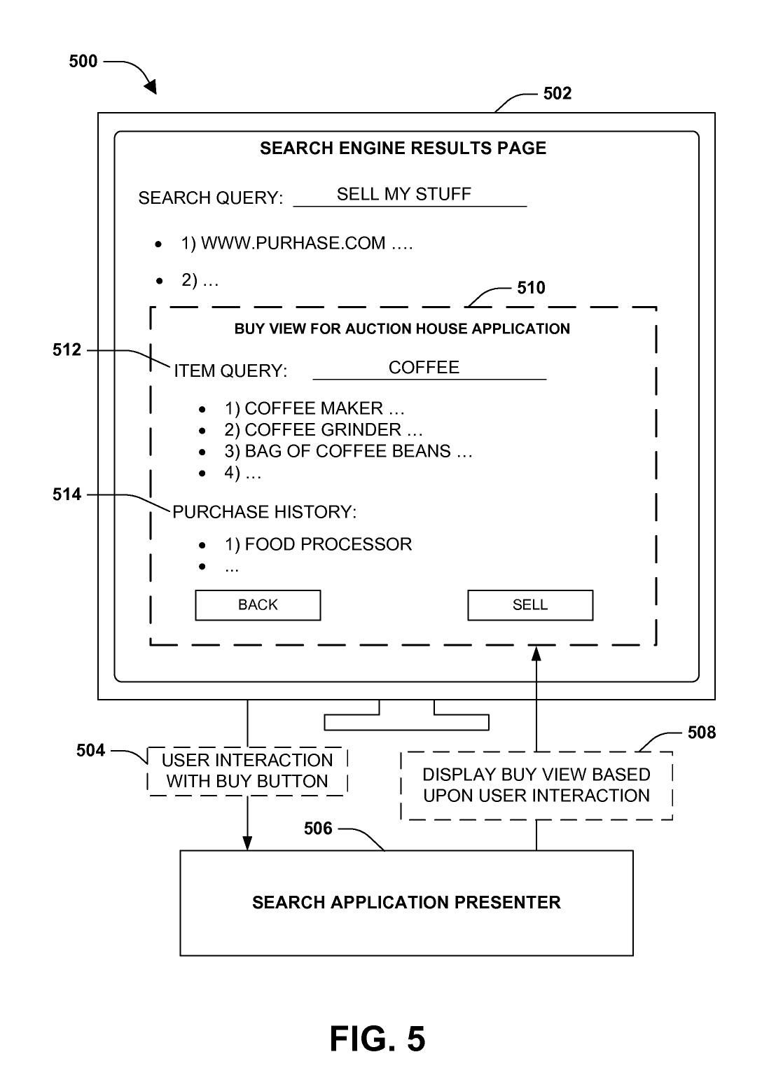

FIG. 5 illustrates an example 500 of displaying a view of a search application based upon user interaction with the search application. It may be appreciated that in one example, a search engine results page 502 of example 500 may correspond to a search engine results page 402 in FIG. 4. The search engine results page 502 may have been displayed to a user that performed a search by submitting a search query “sell my stuff” to a search engine. An auction house application (e.g., an auction house application 418 of FIG. 4) may have been displayed within the search engine results page 502 responsive to a search characteristic of the search corresponding to a condition of the auction house application that triggers display of the auction house application.

The user may navigate to various views of the auction house application based upon user interaction with the auction house application. For example, the user may have clicked a buy button within a currently displayed view of the auction house application (e.g., buy button 426 of FIG. 4) to navigate to a buy view 510 for the auction house application. Accordingly, a search application presenter 506 may be configured to receive the user interaction 504 with the buy button. The search application presenter 506 may determine that the user interaction 504 corresponds to a view condition action, specified for the buy button within the currently displayed view, which triggers display of the buy view 510. For example, the view condition action of the currently displayed view may specify that display of the currently displayed view may be transitioned to the buy view 510 based upon a user clicking the buy button. In this way, the search application presenter 506 may display 508 the buy view 510 within the search engine results page 502 based upon the user interaction 504 with the buy button corresponding to the view condition action specified for the buy button within the currently displayed view. The buy view 510 may provide the user with an interactive experience. In one example, the user may submit an item query 512 to search for items that are for sale through the buy view 510. In another example, the user may view a purchase history 514 through the buy view 510.

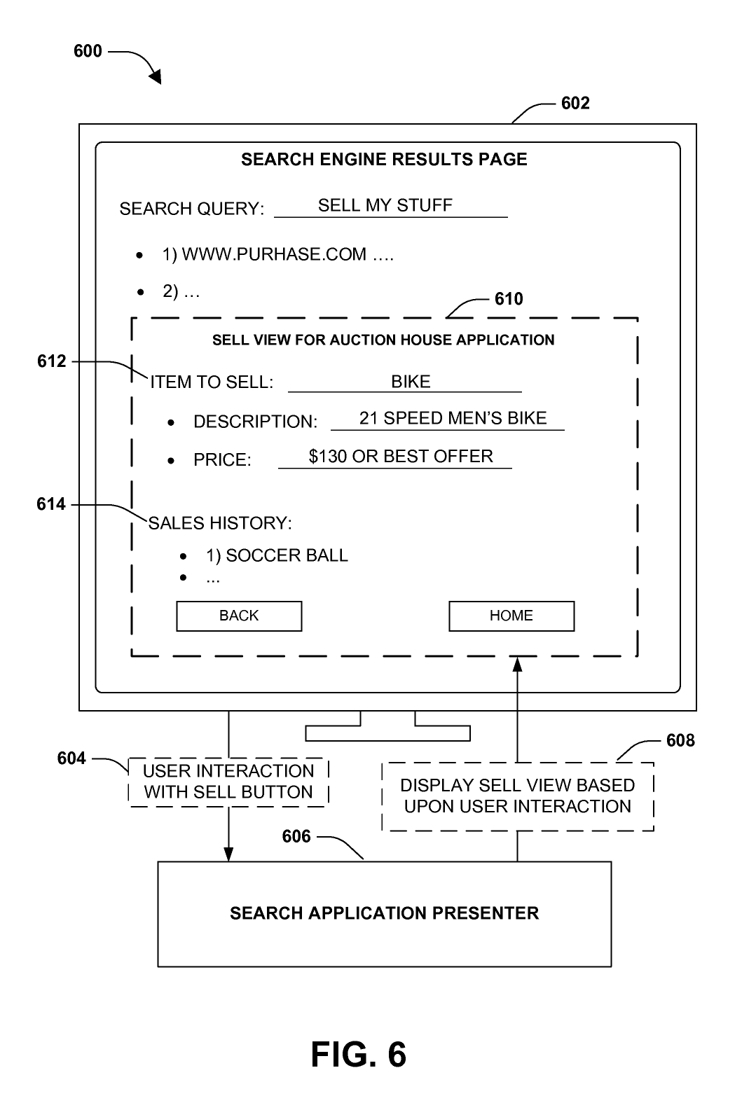

FIG. 6 illustrates an example 600 of displaying a view of a search application based upon user interaction with the search application. It may be appreciated that in one example, a search engine results page 602 of example 600 may correspond to a search engine results page 402 of FIG. 4. The search engine results page 602 may have been displayed to a user that performed a search by submitting a search query “sell my stuff” to a search engine. An auction house application (e.g., an auction house application 418 of FIG. 4) may have been displayed within the search engine results page 602 responsive to a search characteristic of the search corresponding to a condition of the auction house application that triggers display of the auction house application.

The user may navigate to various views of the auction house application based upon user interaction with the auction house application. For example, the user may have clicked a sell button within a currently displayed view of the auction house application (e.g., sell button 428 of FIG. 4) to navigate to a sell view 610 for the auction house application. Accordingly, a search application presenter 606 may be configured to receive the user interaction 604 with the sell button. The search application presenter 606 may determine that the user interaction 604 corresponds to a view condition action, specified for the sell button within the currently displayed view, which triggers display of the sell view 610. For example, the view condition action of the currently displayed view may specify that display of the currently displayed view may be transitioned to the sell view 610 based upon a user clicking the sell button. In this way, the search application presenter 606 may display 608 the sell view 610 within the search engine results page 602 based upon the user interaction 604 with the sell button corresponding to the view condition action specified for the sell button within the currently displayed view. The sell view 610 may provide the user with an interactive experience. In one example, the user may sell 612 (e.g., or list for sale) an item on an auction house through the sell view 610. In another example, the user may view a sales history 614 through the sell view 610.

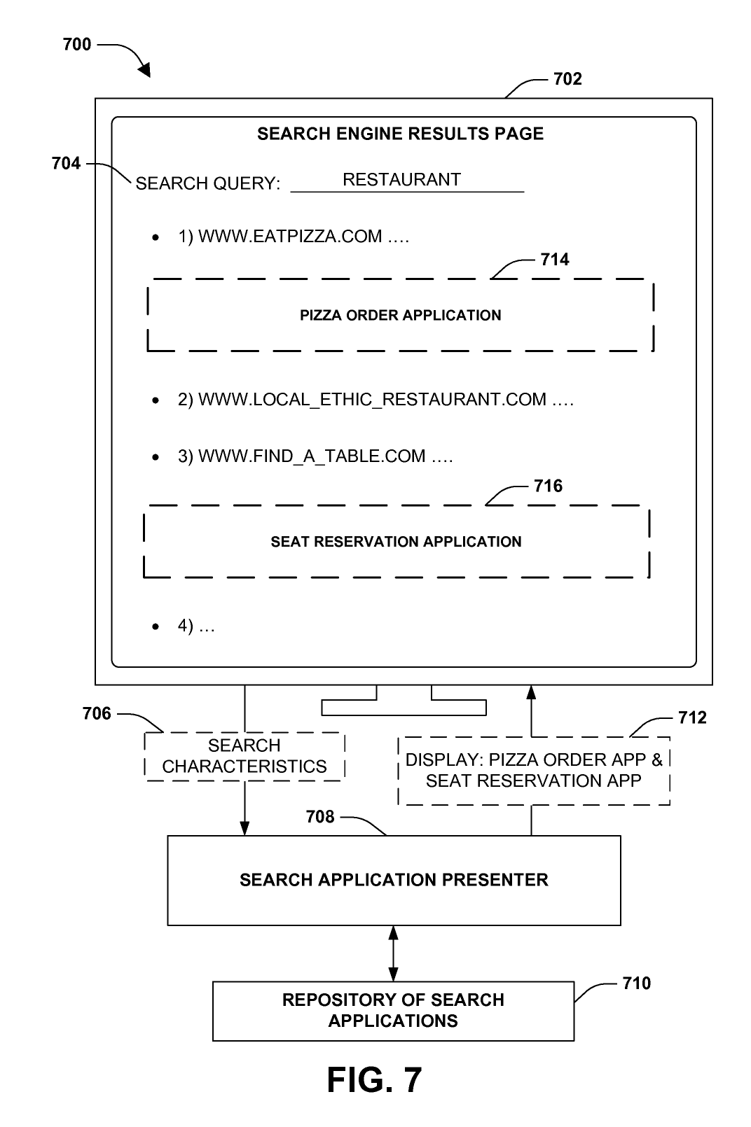

FIG. 7 illustrates an example 700 of displaying a first search application and a second search application within a search engine results page. In one example, a user may perform a search by submitting a search query 704 “restaurant” to a search engine. The search engine may generate one or more search results that may be relevant to the search query 704 “restaurant” (e.g., a URL “www.eatpizza.com” to a pizza website, etc.).

A search application presenter 708 may be configured to determine one or more search characteristics 706 of the search (e.g., a query term “restaurant”, a URL “www.eatpizza.com” of a first search result, a URL “www.find_a_table.com” of a third search result, etc.). The search application presenter 708 may determine whether a search characteristic corresponds to a condition of a search application. For example, a repository of search applications 710 may comprise one or more search applications available for the search application presenter 708 to display within search engine results pages. The search application presenter 708 may determine that the URL “www.eatpizza.com” of the first search result corresponds to a condition of a pizza order application 714. The search application presenter 708 may determine that the URL “www.find_a_table.com” of the third search result corresponds to a condition of a seat reservation application 716. In this way, the search application presenter 708 may display 712 the pizza order application 714 and/or the seat reservation application 716 within the search engine results page 702.

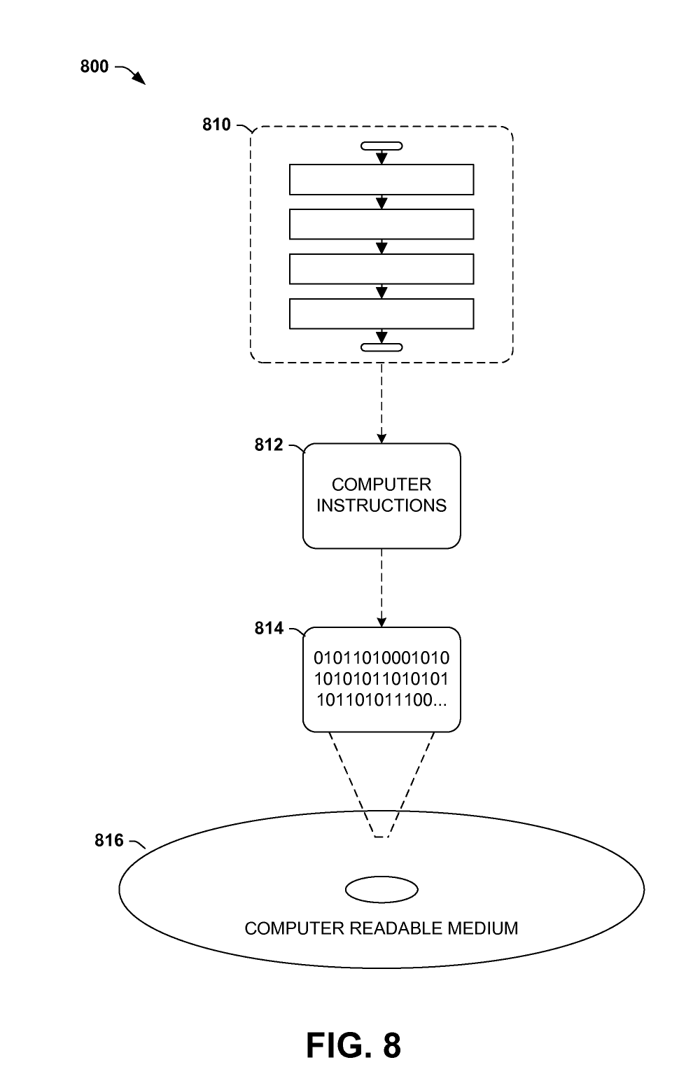

Still another embodiment involves a computer-readable medium comprising processor-executable instructions configured to implement one or more of the techniques presented herein. An exemplary computer-readable medium that may be devised in these ways is illustrated in FIG. 8, wherein the implementation 800 comprises a computer-readable medium 816 (e.g., a CD-R, DVD-R, or a platter of a hard disk drive), on which is encoded computer-readable data 814. This computer-readable data 814 in turn comprises a set of computer instructions 812 configured to operate according to one or more of the principles set forth herein. In one such embodiment 800, the processor-executable computer instructions 812 may be configured to perform a method 810, such as at least some of the exemplary method 100 of FIG. 1 and/or at least some of exemplary method 200 of FIG. 2, for example. In another such embodiment, the processor-executable instructions 812 may be configured to implement a system, such as at least some of the exemplary system 300 of FIG. 3 and/or at least some of exemplary system 400 of FIG. 4, for example. Many such computer-readable media may be devised by those of ordinary skill in the art that are configured to operate in accordance with the techniques presented herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

As used in this application, the terms “component,” “module,” “system”, “interface”, and the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, those skilled in the art will recognize many modifications may be made to this configuration without departing from the scope or spirit of the claimed subject matter.

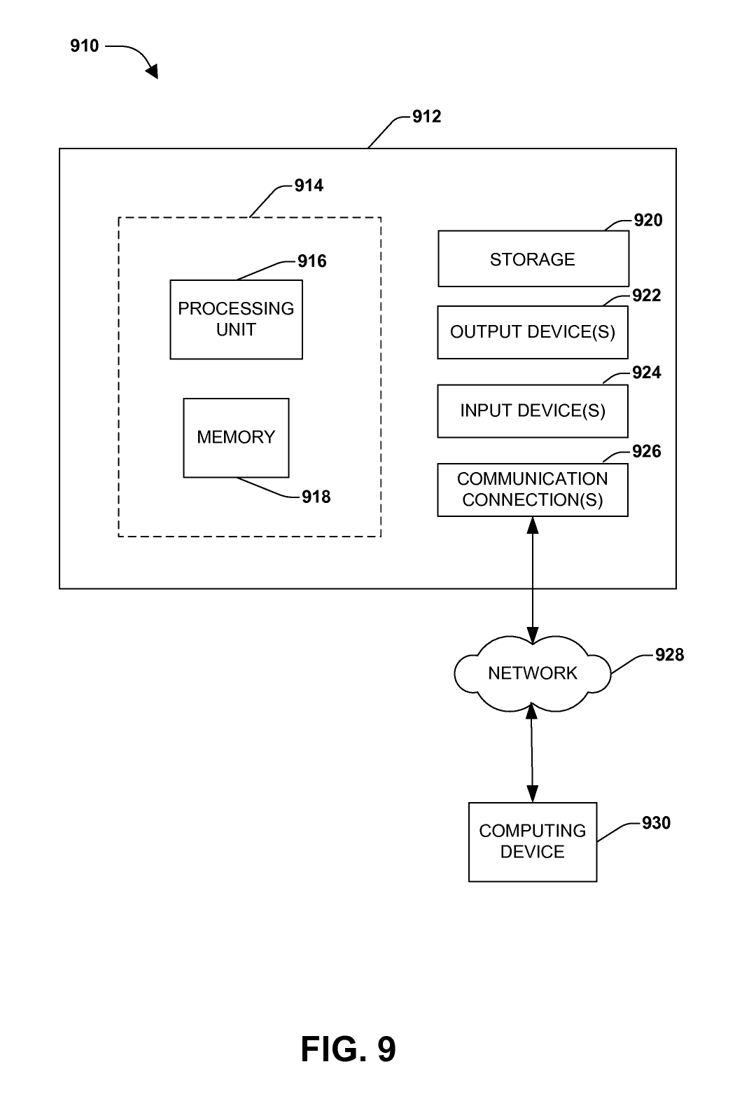

FIG. 9 and the following discussion provide a brief, general description of a suitable computing environment to implement embodiments of one or more of the provisions set forth herein. The operating environment of FIG. 9 is only one example of a suitable operating environment and is not intended to suggest any limitation as to the scope of use or functionality of the operating environment. Example computing devices include, but are not limited to, personal computers, server computers, hand-held or laptop devices, mobile devices (such as mobile phones, Personal Digital Assistants (PDAs), media players, and the like), multiprocessor systems, consumer electronics, mini computers, mainframe computers, distributed computing environments that include any of the above systems or devices, and the like.

Although not required, embodiments are described in the general context of “computer readable instructions” being executed by one or more computing devices. Computer readable instructions may be distributed via computer readable media (discussed below). Computer readable instructions may be implemented as program modules, such as functions, objects, Application Programming Interfaces (APIs), data structures, and the like, that perform particular tasks or implement particular abstract data types. Typically, the functionality of the computer readable instructions may be combined or distributed as desired in various environments.

FIG. 9 illustrates an example of a system 910 comprising a computing device 912 configured to implement one or more embodiments provided herein. In one configuration, computing device 912 includes at least one processing unit 916 and memory 918. Depending on the exact configuration and type of computing device, memory 918 may be volatile (such as RAM, for example), non-volatile (such as ROM, flash memory, etc., for example) or some combination of the two. This configuration is illustrated in FIG. 9 by dashed line 914.

In other embodiments, device 912 may include additional features and/or functionality. For example, device 912 may also include additional storage (e.g., removable and/or non-removable) including, but not limited to, magnetic storage, optical storage, and the like. Such additional storage is illustrated in FIG. 9 by storage 920. In one embodiment, computer readable instructions to implement one or more embodiments provided herein may be in storage 920. Storage 920 may also store other computer readable instructions to implement an operating system, an application program, and the like. Computer readable instructions may be loaded in memory 918 for execution by processing unit 916, for example.

The term “computer readable media” as used herein includes computer storage media. Computer storage media includes volatile and nonvolatile, removable and non-removable media implemented in any method or technology for storage of information such as computer readable instructions or other data. Memory 918 and storage 920 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which can be used to store the desired information and which can be accessed by device 912. Any such computer storage media may be part of device 912.

Device 912 may also include communication connection(s) 926 that allows device 912 to communicate with other devices. Communication connection(s) 926 may include, but is not limited to, a modem, a Network Interface Card (NIC), an integrated network interface, a radio frequency transmitter/receiver, an infrared port, a USB connection, or other interfaces for connecting computing device 912 to other computing devices. Communication connection(s) 926 may include a wired connection or a wireless connection. Communication connection(s) 926 may transmit and/or receive communication media.

The term “computer readable media” may include communication media. Communication media typically embodies computer readable instructions or other data in a “modulated data signal” such as a carrier wave or other transport mechanism and includes any information delivery media. The term “modulated data signal” may include a signal that has one or more of its characteristics set or changed in such a manner as to encode information in the signal.

Device 912 may include input device(s) 924 such as keyboard, mouse, pen, voice input device, touch input device, infrared cameras, video input devices, and/or any other input device. Output device(s) 922 such as one or more displays, speakers, printers, and/or any other output device may also be included in device 912. Input device(s) 924 and output device(s) 922 may be connected to device 912 via a wired connection, wireless connection, or any combination thereof. In one embodiment, an input device or an output device from another computing device may be used as input device(s) 924 or output device(s) 922 for computing device 912.

Components of computing device 912 may be connected by various interconnects, such as a bus. Such interconnects may include a Peripheral Component Interconnect (PCI), such as PCI Express, a Universal Serial Bus (USB), firewire (IEEE 1394), an optical bus structure, and the like. In another embodiment, components of computing device 912 may be interconnected by a network. For example, memory 918 may be comprised of multiple physical memory units located in different physical locations interconnected by a network.

Those skilled in the art will realize that storage devices utilized to store computer readable instructions may be distributed across a network. For example, a computing device 930 accessible via a network 928 may store computer readable instructions to implement one or more embodiments provided herein. Computing device 912 may access computing device 930 and download a part or all of the computer readable instructions for execution. Alternatively, computing device 912 may download pieces of the computer readable instructions, as needed, or some instructions may be executed at computing device 912 and some at computing device 930.

Various operations of embodiments are provided herein. In one embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering will be appreciated by one skilled in the art having the benefit of this description. Further, it will be understood that not all operations are necessarily present in each embodiment provided herein.

Moreover, the word “exemplary” is used herein to mean serving as an example, instance, or illustration. Any aspect or design described herein as “exemplary” is not necessarily to be construed as advantageous over other aspects or designs. Rather, use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims may generally be construed to mean “one or more” unless specified otherwise or clear from context to be directed to a singular form. Also, at least one of A and B and/or the like generally means A or B or both A and B.

Also, although the disclosure has been shown and described with respect to one or more implementations, equivalent alterations and modifications will occur to others skilled in the art based upon a reading and understanding of this specification and the annexed drawings. The disclosure includes all such modifications and alterations and is limited only by the scope of the following claims. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure which performs the function in the herein illustrated exemplary implementations of the disclosure. In addition, while a particular feature of the disclosure may have been disclosed with respect to only one of several implementations, such feature may be combined with one or more other features of the other implementations as may be desired and advantageous for any given or particular application. Furthermore, to the extent that the terms “includes”, “having”, “has”, “with”, or variants thereof are used in either the detailed description or the claims, such terms are intended to be inclusive in a manner similar to the term “comprising.”

What is claimed is:

1. A method for generating a search application for display within a search engine results page, comprising:
receiving a declaration for a search application, the declaration comprising a data binding of a variable value to a variable defined within a template for the search application and a condition that triggers display of the search application within a search engine results page; and
generating the search application based upon the declaration.

2. The method of claim 1, the receiving a declaration comprising:
receiving the declaration defined in declarative XML.

3. The method of claim 1, the data binding comprising at least one of a static string, context based data, an API call to remote data, or a data feed.

4. The method of claim 1, the condition comprising at least one of a grammar based rule, a classifier based rule, or a URL based rule.

5. The method of claim 1, the condition specifying that the search application is to be displayed within the search engine results page based upon at least one of a search query submitted to a search engine, a search result for the search query, or a classified entity associated with the search query.

6. The method of claim 1, the declaration comprising at least one of a condition include list or a condition exclude list.

7. The method of claim 1, the declaration defining a view condition action that triggers display of a first view for the search application, the declaration comprising a view template for the first view, and a view data binding for the first view.

8. The method of claim 7, comprising:
responsive to an occurrence of the view condition action within a currently displayed view of the search application, transitioning the currently displayed view to the first view.

9. The method of claim 1, the template defining an operation that can be invoked for the search application.

10. The method of claim 1, comprising:
responsive to a search characteristic of a search corresponding to the condition, displaying the search application within a search engine results page corresponding to a search query of the search.

11. The method of claim 10, comprising:
responsive to a search characteristic of the search corresponding to a default view of the search application, displaying the default view within the search engine results page.

12. The method of claim 10, the displaying comprising:
binding the variable value to the variable based upon the data binding.

13. The method of claim 10, comprising:
responsive to user interaction with the search application through the search engine results page, invoking the search application to perform an associated operation.

14. A method for displaying a search application within a search engine results page, comprising:
determining one or more search characteristics associated with a search performed using a search engine; and
responsive to a search characteristic corresponding to a condition that triggers display of a search application, displaying the search application within a search engine results page corresponding to a search query of the search, the search application defined by other than a provider of the search engine.

15. The method of claim 14, the displaying comprising:
responsive to a first search characteristic corresponding to a first view condition of a first view of the search application, displaying the first view of the search application within the search engine results page.

16. The method of claim 15, the displaying comprising:
responsive to user interaction with the search application through the search engine results page, displaying a second view of the search application within the search engine results page.

17. The method of claim 14, the displaying comprising at least one of:
binding remote data to a first variable within the search application; or
binding contextual data to a second variable, different than the first variable, within the search application.

18. The method of claim 14, comprising:
responsive to user interaction with the search application through the search engine results page, invoking the search application to perform an associated operation.

19. A system for generating a search application for display within a search engine results page, comprising:
a search application generator configured to:
receive a declaration for a search application, the declaration comprising a data binding of a variable value to a variable defined within a template for the search application and a condition that triggers display of the search application within a search engine results page; and
generate the search application based upon the declaration.

20. The system of claim 19, comprising:
a search application presenter configured to:
responsive to a search characteristic of a search corresponding to the condition display the search application within a search engine results page corresponding to a search query of the search.
